(19) United States
(12) Patent Application Publication
(10) Pub. No.: US 2003/0184957 A1
(43) Pub. Date: Oct. 2, 2003

(54) Computer keyboard integrated in aircraft seatback tray table

(76) Inventors: Robert Edward Stahl, Corona, CA (US); Daniel Dante Poblete, Lake Forest, CA (US)

Correspondence Address: HARNESS, DICKEY & PIERCE, P.L.C., P.O. BOX 828, BLOOMFIELD HILLS, MI, 48303, US

(21) Appl. No.: 10/114,831

(22) Filed: Apr. 2, 2002

(51) Int. Cl. G06F 1/16; A47B 97/00

(52) U.S. Cl. 361/680; 361/683; 312/223.1

(57) ABSTRACT

A keyboard apparatus for communicating with a computer onboard a mobile platform, for example, an aircraft. The keyboard apparatus is connected to the seatback of a passenger seat onboard the mobile platform. The keyboard apparatus is mounted on a frame member. The frame member is pivotally supported by a ring of support members which are in turn coupled to the seatback of the seat. The frames can be rotated to place the keyboard in an “up” position for operation or a down position. In the down position the lower surface of the frame member can be used as a tray table. Several embodiments of the computer keyboard provide various configurations for integrating a pointing device to be used in connection with the keyboard seatback of an aircraft.

### FIELD OF THE INVENTION

The present invention relates generally to integration of computers in aircraft and specifically to the integration of a computer keyboard in an aircraft seatback tray table.

### BACKGROUND OF THE INVENTION

Airline passengers frequently request the opportunity to work with a computer while in flight. A computer can be used by passengers to perform a wide variety of computing operations including reviewing web pages, gathering information, creating documents and performing other work or leisure related activities. A computer is convenient for use during a commercial air flight where several hours can pass between destinations. Further, a computer can be used to connect to a network in order to access additional services including the Internet.

An example of an aircraft based network is “Connexion By Boeing^{SM} ”. Connexion By Boeing^{SM} is a consumer and commercial airline service that offers high-speed data communication services through a space-based network. The system offers air travelers high-speed intranet, email, and Internet services while in-flight. To use these services, a passenger accesses a computer connected to a network on the aircraft that in turn places the user's computer in communication, via a space based communication link, with a ground based component of the system.

Some passengers bring onboard an aircraft their portable computing devices including laptop computers and hand-held computers. However, not all passengers have access to a laptop or hand-held computer thus depriving them of the opportunity to work with a computer by bringing one onboard for their flight. Further, various computing devices such as laptop computers pose several problems in the onboard aircraft environment. This includes providing a power source and connection to a network for the portable computing devices. In addition, laptop computers add to the already limited space in the onboard aircraft environment and introduce an uncontrolled device into the controlled environment of the aircraft. Alternatively, a computer can be integrated into the onboard aircraft environment thus eliminating the need for bringing a computing device onboard an aircraft. However, providing a computer integrated into this environment poses an additional set of problems.

First, is the problem of how best to integrate the computer into the onboard aircraft environment and particularly how to integrate a keyboard and/or pointing device for the computer into the space reserved for a passenger such as a tray table associated with a passenger seat. Any solution must provide convenient direct access by the passenger to the keyboard and/or pointing device in order to operate the computer. An integrated keyboard and/or pointing device that is integrated into a passenger tray table must be accessible, user-friendly, and not prevent use of the passenger tray table for other intended purposes such as holding beverages and meals. Therefore, there is needed an integrated computer comprising an integrated keyboard and/or pointing device that will be easily integrated into the onboard aircraft environment and convenient for passenger use.

It is therefore an object of the invention to provide an integrated keyboard and/or pointing device that solves the above identified problems and fulfills the above identified requirements. This includes the object of providing a convenient, user-friendly solution for integrating a keyboard and/or pointing device (e.g., mouse) into the tray table of a passenger seat of an aircraft.

### SUMMARY OF THE INVENTION

According to preferred embodiments of the present invention, there is provided a keyboard apparatus integrated into a passenger seat of an aircraft. The keyboard apparatus is integrated into an interior compartment of the aircraft and may be disposed in the seatback of the passenger seat. The keyboard apparatus comprises a substantially rectangular member comprising a keyboard device disposed therein suitable for inputting data into a computer. The substantially rectangular member is similar in size and dimension to a seatback tray table commonly found in commercial airlines. The rectangular member may be substantially planar on one side as is common with passenger seatback tray tables. The rectangular member is rotatably attached to support members. This allows the rectangular member to be rotated from a keyboard up position to a keyboard down position, thus allowing the passenger to use the keyboard apparatus as a traditional tray table in the keyboard down position. The rectangular member further comprises locking bosses disposed therein that interact with support members to lock the rectangular member in either the keyboard up position or the keyboard down position. Thus, the passenger can conveniently use the keyboard apparatus as a computer keyboard or alternatively, by rotating the rectangular member to the keyboard down position, the passenger can use the keyboard apparatus as a traditional tray table.

The support members, at their ends opposite the rectangular member, are disposed within the seatback of the passenger seat. This allows for the rectangular member to be rotated from a lowered position into an upright stowed position where the rectangular member is within close proximity to or, alternatively, at least partially disposed within the seatback of the passenger seat.

Several preferred embodiments of the invention are disclosed which disclose different configurations of the keyboard device disposed within the substantially rectangular member. This includes embodiments reflecting the incorporation of a pointing device such as a track ball or a touch pad.

In operation, a passenger or crew member sits in a passenger seat onboard an aircraft with another passenger seat directly in front of him/her. The seat in front of the user has the keyboard apparatus disposed therein. By reaching forward the passenger or crew member is able to lower the keyboard apparatus from the upright stowed position into a lower position where it is accessible for use. If desired, locking bosses on each side of the rectangular member can be depressed allowing the rectangular member comprising the keyboard device to be rotated from a keyboard up position to a keyboard down position, thus providing available space for holding beverages, food or other materials as allowed by a traditional tray table.

### BRIEF DESCRIPTION OF THE DRAWINGS

The present invention will become more fully understood from the detailed description and the accompanying drawings, wherein:

FIG. 1 is a perspective view of the keyboard apparatus of the present invention disposed in the seatback of a passenger seat onboard an aircraft;

FIG. 2 is a perspective view of the keyboard apparatus illustrating rotation of the apparatus from the keyboard up position to a keyboard down position;

FIG. 3 illustrates a preferred embodiment of the keyboard device of the keyboard apparatus;

FIG. 4 illustrates a second preferred embodiment of the keyboard device of the keyboard apparatus with a touch pad pointing device disposed therein; and

FIG. 5 illustrates a third preferred embodiment of the keyboard device of the keyboard apparatus with a track ball pointing device disposed therein.

### DETAILED DESCRIPTION OF THE PREFERRED EMBODIMENTS

The description of the invention is merely exemplary in nature and, thus, variations that do not depart from the gist of the invention are intended to be within the scope of the invention. Such variations are not to be regarded as a departure from the spirit and scope of the invention.

In FIG. 1, a keyboard apparatus 10 in accordance with a preferred embodiment of the present invention is shown disposed in the seatback 12 of an aircraft passenger seat 14 with a display device 16 also disposed within the passenger seat 14. The display device 16 is suitable for connection to a computer and for displaying images and data. The keyboard apparatus 10 comprises a substantially planar rectangular frame member 18 with a keyboard device 20 disposed therein. The rectangular frame member 18 is attached to the seatback 12 of the passenger seat 14 by a first support member 22 and a second support member 22a. The first support member 22 and second support member 22a are preferably pivotally attached to the seatback 12 by suitable fastening elements 23 of the passenger seat 14 so that the first support member 22 and second support member 22a can pivot towards the seatback 12 in accordance with arrow 26. This allows the keyboard apparatus 10 to be stored next to the seatback 12 or alternatively disposed within a recess 24 formed in the seatback 12.

The keyboard device 20 may comprise a QWERTY keyboard comprising alpha pneumatic keys, punctuation keys and specialty keys such as function keys, control keys, arrow keys. The keyboard device 20 may also comprise alternative keyboard designs including keyboard designs featuring non-English language keys.

Referring to FIG. 2, the keyboard apparatus 10 is shown with the rectangular frame member 18 in transition from the keyboard device 20 (refer briefly to FIG. 1) in an upright position wherein it is available for computing use, to the keyboard device 20 in a down position in which the anterior side 50 of the rectangular frame member 18 faces upwardly. The anterior side 50 of the rectangular frame member 18 is suitable for use as a tray table for holding food, beverages etc. As an alternative, the keyboard device 20 can be substantially planar and impermeable to fluids thus providing the keyboard device 20 side of the rectangular frame member 18 as suitable for use as a tray table for holding food, beverages, etc. Rotation to the anterior side 50 of the rectangular frame member 18 is obtained by pivoting the rectangular frame member 18 around pivot axis 54 which extends through the first support member 22 and the second support member 22a. The rectangular frame member 18 is held in place against movement by engagement of a first locking boss 58 disposed within the rectangular frame member 18 with a locking recess 56 disposed within the second support member 22a. A similar locking recess may exist on the first support member 22 to engage with one or more locking bosses disposed on the rectangular frame member 18 which project towards the first support member 22. The first locking boss 58 on the rectangular frame member 18 protrudes from the rectangular frame member 18 and is urged into contact with the locking recess 56 by rotating the rectangular frame member 18 around pivot axis 54 in accordance with arrow 52. The first locking boss 58 is biased into contact with the locking recess 56 by a biasing device such as a coil spring. This allows the first locking boss 58, when urged into contact with the locking recess 56, to engage with the locking recess 56, thus locking the rectangular frame member 18 into a position with the anterior side 50 facing upwardly. Alternatively, the first locking recess 56 allows access to depress the first locking boss 58, thus disengaging the first locking boss 58 from the locking recess 56 and allowing rotation in accordance with arrow 52 of the rectangular frame member 18 to place the keyboard device 20 (FIG. 1) in an upright position. When rotated into the upright position a second locking boss 58a disposed in the rectangular frame member 18 is biased against the locking recess 56 thus locking the rectangular frame member 18 in the upright position. However, it will be appreciated that any suitable locking mechanism could be employed which allows the rectangular frame member 18 to be locked at the two above-described positions.

Referring to FIG. 3, an alternative preferred embodiment of a keyboard device 20a of the keyboard apparatus 10 is shown with a connected track ball 80 pointing device.

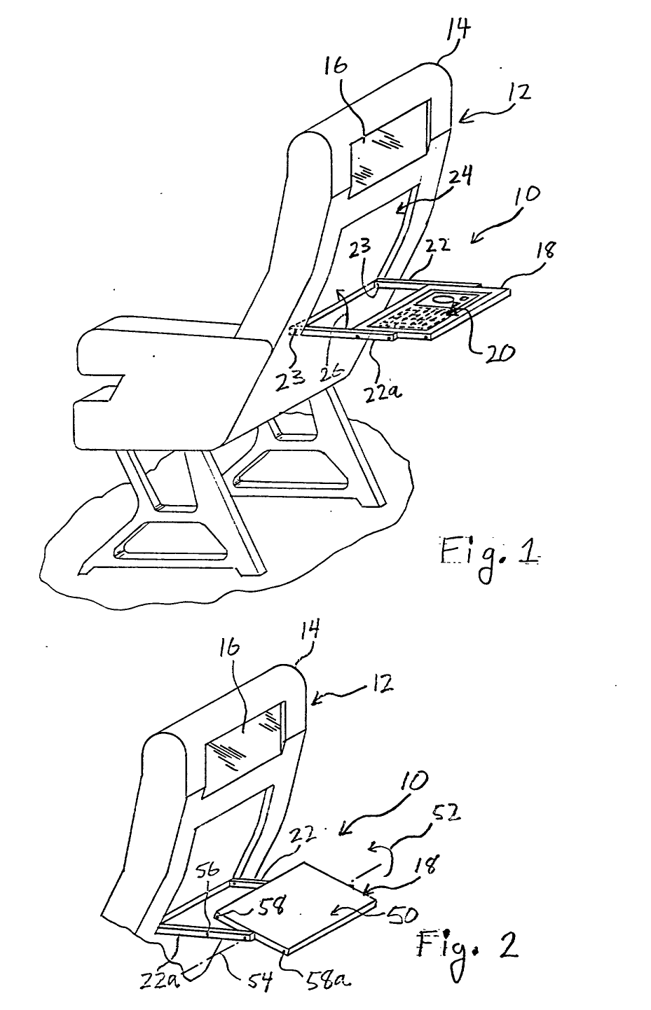

Referring to FIG. 4, a second alternative preferred embodiment of a keyboard device 20b of the keyboard apparatus 10 is shown with a connected touch pad 70 pointing device.

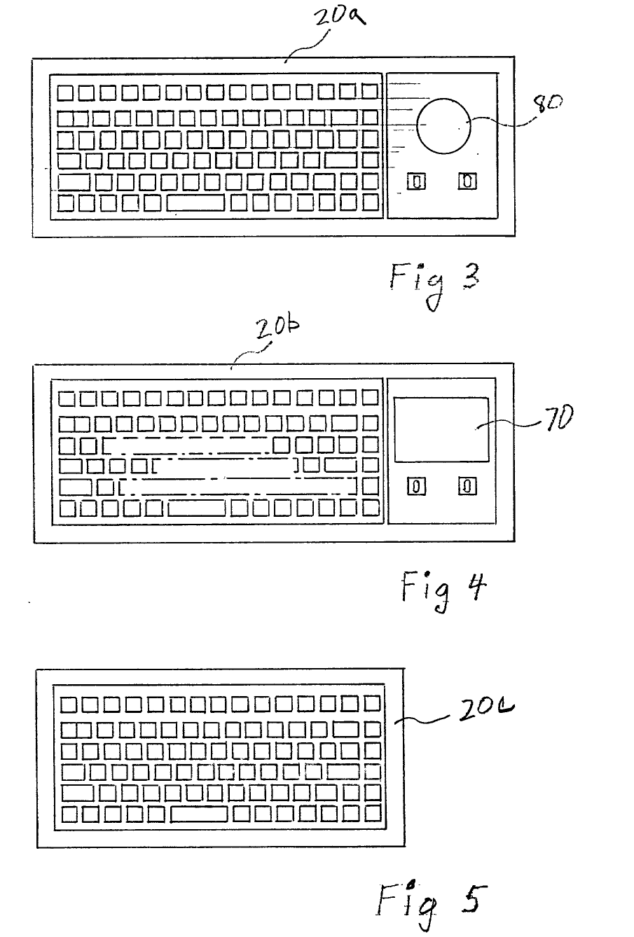

Now referring to FIG. 5, a third alternative preferred embodiment of a keyboard device 20c of the keyboard apparatus 10 is shown with no associated pointing device such as a mouse, track ball or touch pad.

It should be appreciated that while the preferred embodiments are illustrated with various computer keyboards and pointing devices, a wide variety of computer keyboards and pointing devices could be employed with the present invention. The various preferred embodiments of the keyboard apparatus 10 and the ability to easily access the keyboard apparatus 10 thus allows users to work with a onboard computer. The keyboard apparatus 10 of the present invention is unobtrusive and yet easily accessible by users and does not require significant modifications to existing seat assemblies on mobile platforms such as aircraft.

The description of the invention is merely exemplary in nature and, thus, variations that do not depart from the jest of the invention are intended to be within the scope of the invention. Such variations are not to be regarded as a departure from the spirit and scope of the invention.

What is claimed is:

1. A computer keyboard apparatus disposed in a seatback of a seat disposed on a mobile platform, for allowing a user to communicate with a computer, the apparatus comprising:
a frame;
a keyboard having a plurality of keys and supported by said frame;
at least one support member for operatively coupling said frame to said seat;
said frame being pivotally coupled to said support member so that said keyboard can be placed in a first position, wherein said keys are positioned for use by said user, and a second position in which said keys face downwardly and an anterior side of said frame can be used as a tray table by said user; and
a manually engageable locking system for securing said frame in said first and second positions such that said keyboard cannot be inadvertently moved from either of said first and second positions by said user without said user first engaging said locking system to release said locking system.

2. The apparatus of claim 1, wherein said seatback includes a recess shaped to accommodate said frame and said keyboard.

3. The apparatus of claim 1, wherein said support member is pivotally coupled to said seat to enable said frame and said keyboard to be pivotally moved into a position closely adjacent said seatback of said seat.

4. The apparatus of claim 1, further comprising a pair of support members for supporting said frame.

5. The apparatus of claim 1, wherein said locking system comprises a boss portion disposed on one of said frame and said support member, and a cooperating locking structure disposed on the other one of said frame and support member.

6. The apparatus of claim 1, wherein said keyboard further comprises at least one of the group comprising a mouse, a trackball and a touch pad.

7. A computer keyboard apparatus disposed in a seatback of a seat disposed on a mobile platform, for allowing a user to communicate with a computer, the apparatus comprising:
a frame forming a platform;
a keyboard having a plurality of keys and secured to said frame;
a pair of support members pivotally coupled to said frame at first ends thereof and coupled to said seatback of said seat at second ends thereof;
said frame being pivotally moveable about said support members so that said keyboard can be placed in an upright position, wherein said keys are positioned for use by said user, and a downwardly facing position in which said keys face downwardly and an anterior side of said frame can be used as a tray table by said user; and
a manually engageable locking system operatively associated with at least one of said support members and also with said frame, for securing said frame in said first and second positions such that said keyboard cannot be inadvertently moved from either of said first and second positions by said user without said user first manually engaging said locking system to release said locking system.

8. The apparatus of claim 7, wherein said support members are pivotally secured to said seatback.

9. The apparatus of claim 7, wherein said keyboard further comprises a pointing device comprising one of the group of a mouse, a track ball and a touch pad.

10. A computer keyboard apparatus adapted for use onboard a mobile platform by a passenger of the mobile platform, said apparatus comprising:
a substantially rectangular frame member coupled to a seatback of a seat of said mobile platform;
a keyboard having a plurality of keys for communicating with a computer, said keyboard being secured to said frame so as to be immovable from said frame; and
at least one linear, elongated support member connected at one end thereof to the frame and at an opposite end thereof pivotally to said seatback;
wherein said linear support member is pivotal to place said keyboard in a stowed position closely adjacent said seatback, and in an operative position wherein said keyboard is accessible for use by said passenger; and
wherein said frame is rotatably coupled to said support member to enable said keyboard to rotated from said operative position to a position wherein said keys are facing downwardly, to thereby enable a lower surface of said frame to be used as a tray table by said passenger.

11. The apparatus of claim 10, further comprising a locking mechanism for locking said keyboard stationary in either said operative position or in said position facing downwardly.

13. The apparatus of claim 11, wherein said locking mechanism is manually engageable by said user to release said locking mechanism and allow rotational movement of said frame.
